(19) United States
(12) Patent Application Publication
(10) Pub. No.: US 2023/0315034 A1
(43) Pub. Date: Oct. 5, 2023

(54) DISPLAY DEVICE

(71) Applicant: FANUC CORPORATION, Yamanashi (JP)

(72) Inventors: Tomoyuki AIZAWA, Yamanashi (JP); Junichi TEZUKA, Yamanashi (JP); Satoshi IKAI, Yamanashi (JP)

(73) Assignee: FANUC CORPORATION, Yamanashi (JP)

(21) Appl. No.: 18/044,069

(22) PCT Filed: Sep. 1, 2021
(86) PCT No.: PCT/JP2021/032057

§ 371 Date: Mar. 3, 2023

(30) Foreign Application Priority Data
Sep. 7, 2020 (JP) 2020-149698

(51) Int. Cl. G05B 15/02; G06F 3/14

(52) U.S. Cl. CPC G05B 15/02; G06F 3/14

(57) ABSTRACT

This display device comprises a determination unit and a display unit 18. The determination unit monitors the trajectory difference between an actual trajectory and a trajectory in a machining program for a spindle, and: determines, with regard to a site at which the trajectory difference is small and the actual speed of the spindle is small relative to the maximum value setting for a command speed, whether accuracy can be maintained even if the command speed is increased; and/or determines, with regard to a site at which the trajectory difference is small and the actual acceleration of the spindle is small relative to the maximum value setting for a command acceleration, whether accuracy can be maintained even if the command acceleration is increased. The display unit 18 displays the site in a highlighted manner.

### TECHNICAL FIELD

The present invention relates to a display device.

### BACKGROUND ART

Patent Document 1 discloses that an “advantage of the method according to the present invention is that the sections of the trajectory curve in which no large deviation of an actual trajectory from the target trajectory is expected or takes place are displayed at a smaller scale, and the sections of the trajectory curve in which large deviations of actual trajectory from the target trajectory are expected or take place are displayed at a larger scale”.

Patent Document 2 discloses that “the present invention makes it possible to check a machining error by executing a machining program in an idle operation by which a workpiece is not machined, and drawing an actual tool route obtained at that time on a display device or drawing a positional deviation obtained at that time on the display device. In addition, the present invention makes it possible to check a machining error by drawing an actual route by changing a line type only for a section in which a positional deviation exceeds a set limit value”.

Patent Document 3 discloses that “the invention as defined in claim 1 provides a trajectory display device adapted to display a three-dimensional trajectory of an actual position of an object, a three-dimensional position of the object being controlled by a numerical controller, the trajectory display device comprising: a commanded position data acquisition unit adapted to acquire data of a commanded position of the object at discrete time intervals; an actual position data acquisition unit adapted to acquire data of an actual position of the object at discrete time intervals; a command line segment defining unit adapted to define a command line segment which connects two temporally adjacent points, in relation to each point corresponding to the commanded position; an error calculating unit adapted to calculate an error of the actual position relative to a commanded trajectory, the error being determined as a shorter one between a length of a shortest normal line among normal lines each extending from the actual position to the command line segment at each discrete time and a length of a line segment extending from the actual position to a commanded position which is the nearest from the actual position; and at least one of an error displaying unit adapted to display the error and an outputting unit adapted to output the error to the outside”.

Patent Document 1: Japanese Unexamined Patent Application, Publication No. H11-345011
Patent Document 2: Japanese Unexamined Patent Application, Publication No. H11-143514
Patent Document 3: Japanese Unexamined Patent Application, Publication No. 2011-060016

### DISCLOSURE OF THE INVENTION

### Problems to Be Solved by the Invention

It is desirable to provide a display device which makes it possible to maintain machining accuracy and shorten a cycle time.

### Means for Solving the Problems

(1) An aspect of the present disclosure provides a display device provided in a servo control device that controls an electric motor configured to drive an axis of an industrial machine, the display device comprising: a determination unit that monitors a trajectory difference between a trajectory of a machining program of the axis and an actual trajectory, and makes at least one of a determination that accuracy is maintainable even when a command speed is increased at a portion where the trajectory difference is small and an actual speed of the axis is small with respect to a set maximum value of the command speed and a determination that accuracy is maintainable even when a command acceleration is increased at a portion where the trajectory difference is small and an actual acceleration of the axis is small with respect to a set maximum value of the command acceleration; and a display unit that highlights the portion.

### Effects of the Invention

According to one aspect, the present disclosure makes it possible to maintain machining accuracy and shorten a cycle time.

### BRIEF DESCRIPTION OF THE DRAWINGS

FIG. 1 is a diagram showing a mechanical system including a display device according to one embodiment;

FIG. 2 is a diagram showing a highlight displayed on an image display unit of the display device according to one embodiment; and

FIG. 3 is a diagram showing control in the display device according to one embodiment.

### PREFERRED MODE FOR CARRYING OUT THE INVENTION

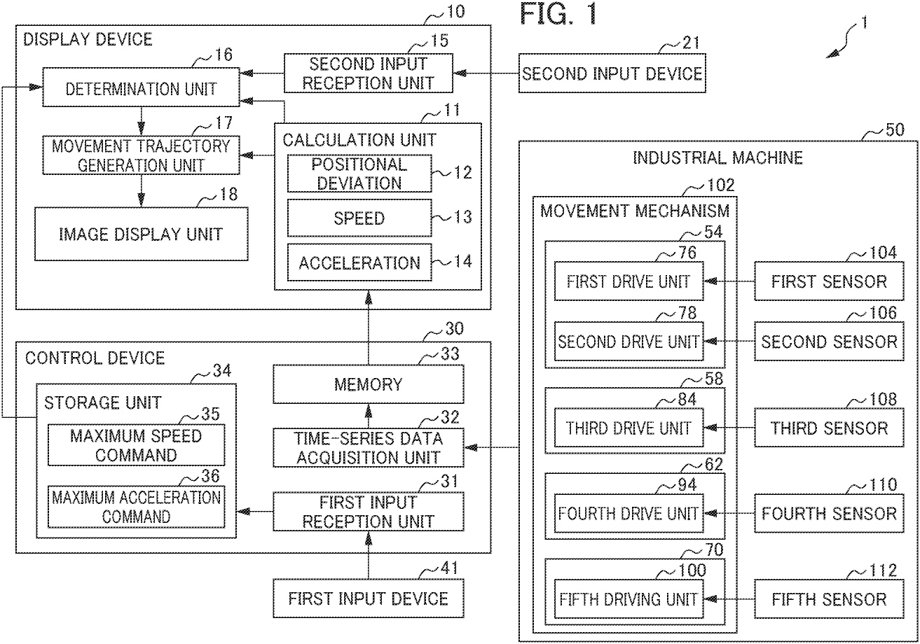

Hereinafter, an example of an embodiment will be described. FIG. 1 is a diagram showing a mechanical system 1 including a display device 10. The mechanical system 1 includes a control device 30, a display device 10, a first input device 41, a second input device 21, and an industrial machine 50. The industrial machine 50 comprises, for example, a machine tool, in the present embodiment.

The control device 30 controls the operation of the display device 10, the first input device 41, the second input device 21, and the industrial machine 50. Specifically, the control device 30 includes, for example, a CPU or GPU, and includes a processor that performs arithmetic processing for executing various functions described later and an I/O interface, and includes a memory 33, a storage unit 34, a time-series data acquisition unit 32, and a first input reception unit 31 to constitute a CNC device. The processor of the control device 30 is communicably connected to the memory 33 and the I/O interface via a bus (not shown).

The memory 33 includes, for example, a ROM or RAM, and stores various types of data temporarily or permanently. The memory 33 outputs the various types of data stored therein to a calculation unit 11 of the display device 10. The storage unit 34 stores a maximum speed command 35 and a maximum acceleration command 36, and outputs the maximum speed command 35 and the maximum acceleration command 36 stored therein to a determination unit 16 of the display device 10. The maximum speed command 35 is a maximum value of a speed command which can be input to a servo motor (not shown) of the industrial machine 50, and the maximum acceleration command 36 is a maximum value of an acceleration command which can be input to the servo motor (not shown) of the industrial machine 50. The maximum speed command 35 and the maximum acceleration command 36 are predetermined with respect to each industrial machine 50. A speed command and an acceleration command are parameters used to control the servo motor by the CNC device.

The time-series data acquisition unit 32 receives and acquires, from the industrial machine 50, time-series data of a position of a driving body of the industrial machine 50 or each axis of an electric motor when the industrial machine 50 performs so-called idle machining in which a machining program of the industrial machine 50 is executed without actual machining on a workpiece serving as an object to be machined, together with a machining program used when the industrial machine 50 machines the workpiece. Then, the time-series data acquisition unit 32 causes the memory 33 to store the received data and machining program.

The first input device 41 outputs, to the first input reception unit 31, each maximum value (the maximum speed command 35 and the maximum acceleration command 36) of a speed command and an acceleration command based on the machining program used when the industrial machine 50 machines a workpiece. The first input reception unit 31 receives the maximum speed command 35 and the maximum acceleration command 36 output from the first input device 41 and causes the storage unit 34 to store them.

The display device 10 includes a calculation unit 11, a second input reception unit 15, a determination unit 16, a movement trajectory generation unit 17, and an image display unit 18. The calculation unit 11 calculates a speed, an acceleration, and a positional deviation on the basis of position data which is the time-series data of a position of the driving body of the industrial machine 50 or each axis of the electric motor, the position data being received from the memory 33. The calculation unit 11 outputs the calculated speed, acceleration and positional deviation to the determination unit 16 and the movement trajectory generation unit 17.

The second input device 21 outputs, to the second input reception unit 15, ratios to a maximum command speed and a maximum command acceleration which are control parameters of each axis, and an acceptable trajectory difference. The second input reception unit 15 receives the ratios to a maximum command speed and a maximum command acceleration, and the acceptable trajectory difference that are output from the second input device 21, and outputs them to the determination unit 16.

The determination unit 16 determines whether there is a portion where a cycle time can be shortened, on the basis of the positional deviation, an actual speed and an actual acceleration which are the speed and the acceleration, the positional deviation, the actual speed, and the actual acceleration being received from the calculation unit 11, the maximum speed command 35 which is a maximum value of the command speed, and the maximum acceleration command 36 which is a maximum value of the command acceleration, the maximum speed command 35 and the maximum acceleration command 36 being received from the storage unit 34. In the case where it is determined that the cycle time can be shortened, the determination unit 16 outputs the information about the portion where the cycle time can be shortened to the movement trajectory generation unit 17.

The movement trajectory generation unit 17 generates a movement trajectory of each axis on the basis of the actual position or the position command. In addition, the movement trajectory generation unit 17 generates data for displaying a portion corresponding to the position where the cycle time can be shortened in the generated movement trajectory, on the basis of the information about the portion where the cycle time can be shortened that is received from the determination unit 16. Then, the movement trajectory generation unit 17 outputs the generated information (data) to the image display unit 18.

The image display unit 18 includes a display such as an LCD or an organic EL display, and displays the data for the movement trajectory and the data for the portion where the cycle time can be shortened on the display of the image display unit 18 so that these pieces of data are superimposed on each other, using the data on the movement trajectory generated by the movement trajectory generation unit 17 and the data on the portion where the cycle time can be shortened. The image display unit 18 highlights the portion where the cycle time can be shortened in the movement trajectory to allow the portion to be easily visibly recognized.

The industrial machine 50 is a so-called five-axis machining center, and machines a workpiece. The industrial machine 50 includes a translational movement mechanism 54, a swinging movement mechanism 58, a rotational movement mechanism 62, and a spindle movement mechanism 70. The translational movement mechanism 54 includes an x-axis ball screw mechanism (not shown) that reciprocates a base table (not shown) in an x-axis direction and a y-axis ball screw mechanism (not shown) that reciprocates the base table in a y-axis direction, and further includes a first drive unit 76 and a second drive unit 78 that drive the x-axis ball screw mechanism and the y-axis ball screw mechanism, respectively.

The first drive unit 76 is, for example, a servo motor, and rotationally drives its rotary shaft according to a command from the control device 30. The x-axis ball screw mechanism converts rotation operation of an output shaft of the first drive unit 76 into a reciprocating movement along the x axis of the machine coordinate system. Similarly, the second drive unit 78 is, for example, a servo motor, and rotationally drives its rotary shaft according to a command from the control device 30, and the y-axis ball screw mechanism coverts rotation operation of an output shaft of the second drive unit 78 into a reciprocating movement along the y axis of the machine coordinate system.

The swinging movement mechanism 58 includes a third drive unit 84. The third drive unit 84 is, for example, a servo motor, and rotationally drives its output shaft according to a command from the control device 30.

The rotational movement mechanism 62 includes a fourth drive unit 94. The fourth drive unit 94 is, for example, a servo motor, and rotationally drives its output shaft according to a command from the control device 30.

The spindle movement mechanism 70 includes a ball screw mechanism (not shown) that reciprocates a spindle head in a z-axis direction and a fifth drive unit 100 that drives the ball screw mechanism. The fifth drive unit 100 is, for example, a servo motor, and rotationally drives its rotary shaft according to a command from the control device 30, and the ball screw mechanism coverts rotation operation of an output shaft of the fifth drive unit 100 into a reciprocating movement along the z axis of the machine coordinate system.

The machine coordinate system is set for the industrial machine 50. The machine coordinate system is an orthogonal coordinate system fixed in a three-dimensional space, and serves as a reference in automatically controlling the operation of the industrial machine 50.

The industrial machine 50 moves a tool (not shown) relative to a workpiece set on a work table (not shown) in five directions by means of the translational movement mechanism 54, the swinging movement mechanism 58, the rotational movement mechanism 62, and the spindle movement mechanism 70. Accordingly, the translational movement mechanism 54, the swinging movement mechanism 58, the rotational movement mechanism 62, and the spindle movement mechanism 70 constitute a movement mechanism that moves the tool and the workpiece relative to each other.

The industrial machine 50 includes a first sensor 104, a second sensor 106, a third sensor 108, a fourth sensor 110, and a fifth sensor 112. The first sensor 104 is provided for the first drive unit 76, detects state data of the first drive unit 76, and transmits the state data to the control device 30 as feedback. The first sensor 104 includes a rotation detection sensor (an encoder, a Hall element, or the like) that detects a rotation position (or a rotation angle) of the output shaft of the first drive unit 76. A servo amplifier that causes a current to flow in the servo motor of each drive unit includes therein a current sensor that detects the current flowing in each drive unit. The current sensor detects the current as the state data of each drive unit, and transmits, to the control device 30, current feedback indicating the current, as feedback.

The second sensor 106 includes a rotation detection sensor that detects a rotation position of the output shaft of the second drive unit 78, and a current sensor that detects a current flowing in the second drive unit 78, and detects the rotation position, the speed and the current as the state data of the second drive unit 78. Then, the second sensor 106 transmits, to the control device 30, the position feedback of the rotation position, the speed feedback of the speed, and the current feedback of the current, as feedback.

The third sensor 108 includes a rotation detection sensor that detects a rotation position of the output shaft of the third drive unit 84, and a current sensor that detects a current flowing in the third drive unit 84, and detects the rotation position, the speed and the current as the state data of the third drive unit 84. Then, the third sensor 108 transmits, to the control device 30, the position feedback of the rotation position, the speed feedback of the speed, and the current feedback of the current, as feedback.

The fourth sensor 110 includes a rotation detection sensor that detects a rotation position of the output shaft of the fourth drive unit 94, and a current sensor that detects a current flowing in the fourth drive unit 94, and detects the rotation position, the speed and the current as the state data of the fourth drive unit 94. Then, the fourth sensor 110 transmits, to the control device 30, the position feedback of the rotation position, the speed feedback of the speed, and the current feedback of the current, as feedback.

The fifth sensor 112 includes a rotation detection sensor that detects a rotation position of the output shaft of the fifth drive unit 100, and a current sensor that detects a current flowing in the fifth drive unit 100, and detects the rotation position, the speed and the current as the state data of the fifth drive unit 100. Then, the fifth sensor 112 transmits, to the control device 30, the position feedback of the rotation position, the speed feedback of the speed, and the current feedback of the current, as feedback. When a workpiece is machined by the industrial machine 50, the processor of the control device 30 transmits commands CD1, CD2, CD3, CD4, and CD5 to the first drive unit 76, the second drive unit 78, the third drive unit 84, the fourth drive unit 94, and the fifth drive unit 100, respectively, according to the machining program. The command CD1 to be transmitted to the first drive unit 76 includes at least one of a position command, a speed command, a torque command, and a current command, for example.

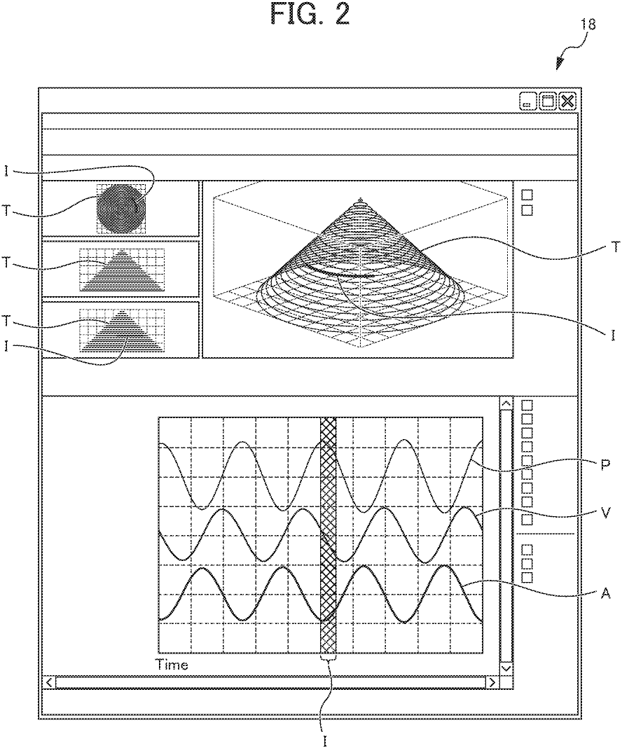

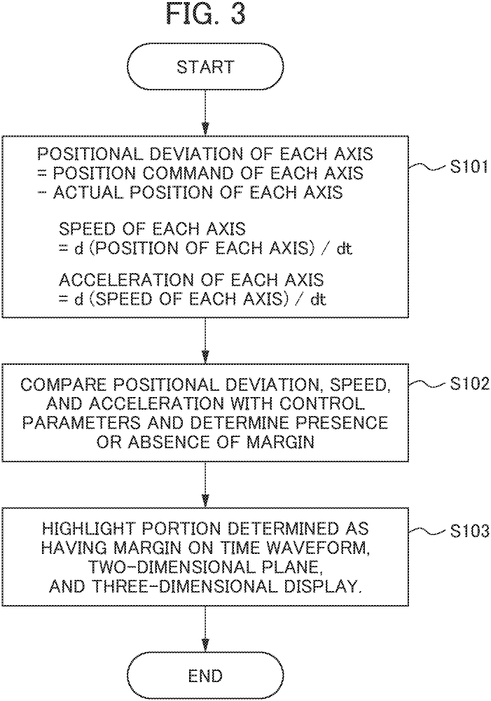

Next, there will be described control to highlight a portion where the cycle time can be shortened in the movement trajectory to allow the portion to be easily visibly recognized. FIG. 2 is a diagram showing a highlight display portion I displayed by the image display unit 18 of the display device 10. FIG. 3 is a diagram showing control in the display device 10.

First, the control device 30 controls the industrial machine 50 to perform the idle machining in the industrial machine 50. Thus, the calculation unit 11 of the display device 10 receives, from the memory 33, the position data which is the time-series data of a position of the driving body of the industrial machine 50 or each axis of the electric motor, and calculates a positional deviation, a speed (actual speed), and an acceleration (actual acceleration) using the position data (step S101). Here, the positional deviation in each axis is calculated by subtracting the actual position of each axis from the position command of each axis. The speed (actual speed) for each axis is a value obtain by first-order differentiation of the position obtained from the position data for each axis. The acceleration (actual acceleration) for each axis is a value obtain by first-order differentiation of the speed (actual speed) for each axis.

Next, the determination unit 16 determines whether there is a portion where the cycle time can be shortened, on the basis of a positional deviation 12 output from the calculation unit 11, an actual speed and an actual acceleration which are a speed 13 and an acceleration 14, the maximum speed command 35 which is a maximum value of the command speed, and the maximum acceleration command 36 which is a maximum value of the command acceleration, the maximum speed command 35 and the maximum acceleration command 36 being received from the storage unit 34 of the control device 30 (step S102).

Specifically, the determination unit 16 compares a trajectory of the machining program which is a trajectory generated from position commands for five axes and an actual trajectory which is a trajectory generated from the actual positions for the five axes, and monitors a trajectory difference between the trajectory of the machining command and the actual trajectory on the basis of the speed 13 and the acceleration 14.

The determination unit 16 determines that the accuracy can be maintained even when the command speed is increased at a portion where the trajectory difference is small and the actual speed of each axis is small with respect to the maximum command speed which is a control parameter of each axis, the maximum command speed being output from the storage unit 34. The determination unit 16 determines that the accuracy can be maintained even when the command acceleration is increased at a portion where the trajectory difference is small and the actual acceleration of each axis is small with respect to the maximum command acceleration which is a control parameter of each axis, the maximum command acceleration being output from the storage unit 34. Here, describing the term “small”, if the command speed and the command acceleration are smaller than the maximum command speed and the maximum command acceleration, respectively by 20%, for example, this means that the command speed and the command acceleration are sufficiently small. Then, the determination unit 16 outputs, to the movement trajectory generation unit 17, the information about the portion where the cycle time can be shortened, as the data.

The movement trajectory generation unit 17 generates data of a movement trajectory capable of being displayed on the image display unit 18, on the basis of the position data (the actual position or the position command) output from the calculation unit 11 to the movement trajectory generation unit 17. The movement trajectory generation unit 17 generates data capable of being displayed on the image display unit 18 and to be superimposed on the movement trajectory to be capable of being highlighted, on the basis of the data for the portion where the cycle time can be shortened, the data being received from the determination unit 16. Then, the movement trajectory generation unit 17 outputs the generated pieces of data to the image display unit 18.

The image display unit 18 displays the highlight display portion I which is a portion where the cycle time can be shortened in the figure showing a movement trajectory T as shown in FIG. 2 using the data received from the movement trajectory generation unit 17, and displays the highlight display portion I showing a region of the portion where the cycle time can be shortened, in a graph showing the positional deviation, the command speed, and the command acceleration. Furthermore, for example, when the highlight display portion I in the graph is tapped on the display constituting the image display unit 18, a row number of the machining program corresponding to the portion where the cycle time can be shortened is displayed, as the corresponding portion in the machining program, on the display.

The present embodiment as described above exhibits the following effects. In the present embodiment, the determination unit 16 monitors the trajectory difference between the trajectory of the machining program of each axis and the actual trajectory (movement trajectory T). The determination unit 16 determines that the accuracy can be maintained even when the command speed is increased at a portion where the trajectory difference is small and the actual speed of each axis is small with respect to the maximum command speed in setting of the command speed. The determination unit 16 determines that the accuracy can be maintained even when the command acceleration is increased at a portion where the trajectory difference is small and the actual acceleration of each axis is small with respect to the set maximum value of the command acceleration. Then, the image display unit 18 highlights the portion as the highlight display portion I.

In this way, the image display unit 18 highlights the portion where the trajectory difference is small, which can prompt correction of the machining program for the portion, whereby the machining program can be corrected while maintaining the machining accuracy. Furthermore, the image display unit 18 highlights the portion where the actual speed and the actual acceleration of each axis are small with respect to the set maximum values of the command speed and the command acceleration, respectively, which can prompt the correction of the machining program, whereby the portion where the cycle time can be significantly shortened can be easily visibly recognized. As described above, the machining program can be corrected while maintaining the machining accuracy. As a result, it is possible to optimize servo control for a change in the movement state of each axis. In addition, it is possible to effectively obtain parameters used to control the servo motor by the CNC device, shorten the time required to reach the parameters, and improve the efficiency of start-up of the industrial machine 50.

In the present embodiment, the image display unit 18 can display a portion corresponding to a portion in the machining program. This enables a portion where the cycle time can be shortened to be easily visibly recognized on the machining program. This makes it possible to easily correct the machining program.

The present embodiment has been described above. While the embodiment described above is a preferred embodiment, the present invention is not limited only to this embodiment, but may be implemented in forms to which various changes are made. For example, the invention may be implemented in a changed form such as Modification Example described below. For example, in the above-described embodiment, it is determined that the accuracy can be maintained even when the command speed is increased at a portion where the trajectory difference is small and the actual speed of each axis is small with respect to the set maximum value of the command speed, and it is determined that the accuracy can be maintained even when the command acceleration is increased at a portion where the trajectory difference is small and the actual acceleration of each axis is small with respect to the set maximum value of the command acceleration, but the present invention is not limited thereto. It is only required that the determination unit 16 makes at least one of a determination that the accuracy can be maintained even when the command speed is increased at a portion where the trajectory difference is small and the actual speed of each axis is small with respect to the set maximum value of the command speed and a determination that the accuracy can be maintained even when the command acceleration is increased at a portion where the trajectory difference is small and the actual acceleration of each axis is small with respect to the set maximum value of the command acceleration. The display device needs not be incorporated in the control device, and, for example, may be provided separately from the control device to be electrically connected to the control device. In the present embodiment, the time-series data is used, indicating a position of the driving body of the industrial machine 50 or each axis of the electric motor when a so-called idle machining is performed, but the present invention is not limited, and, for example, data may be used, indicating actual machining when the machining is actually performed. In the present embodiment, the industrial machine 50 is a so-called five-axis machining center, but the present invention is not limited to the five-axis machining center. In the present embodiment, the industrial machine 50 includes the first sensor 104, the second sensor 106, the third sensor 108, the fourth sensor 110, and the fifth sensor 112, and these sensors each include a rotation detection sensor (an encoder, a Hall element, or the like) that detects a rotation position (or a rotation angle) of the output shaft of each drive unit, but the present invention is not limited to this configuration. For example, as the sensor, not only a detector that detects a rotation position or a rotation angle but also a detector (a linear scale) of a position of the drive unit (a linear motion system) may be used.

Each configuration of the determination unit, the display unit, and the like is not limited to each configuration of the determination unit 16, the image display unit 18, and the like in the present embodiment. The industrial machine 50 comprises a machine tool in the present embodiment, but is not limited thereto, and may comprise another industrial machine other than the machine tool. Furthermore, in the present embodiment, the determination unit monitors the trajectory difference between the trajectory of the machining program of each axis and the actual trajectory, but the present invention is not limited thereto. The determination unit may monitor the actual speed and the actual acceleration. As shown in FIG. 2, the movement trajectory T is shown on the three-dimensional display, but if axes move in the plane, the movement trajectory T may be shown on the two-dimensional plane.

### EXPLANATION OF REFERENCE NUMERALS

10 Display device
18 Image display unit
30 Control device (servo control device)
50 Industrial machine
I Highlight display unit
T Movement trajectory (actual trajectory)

1. A display device provided in a servo control device that controls an electric motor configured to drive an axis of an industrial machine, the display device comprising:
a determination unit that monitors a trajectory difference between a trajectory of a machining program of the axis and an actual trajectory, and makes at least one of a determination that accuracy is maintainable even when a command speed is increased at a portion where the trajectory difference is small and an actual speed of the axis is small with respect to a set maximum value of the command speed and a determination that accuracy is maintainable even when a command acceleration is increased at a portion where the trajectory difference is small and an actual acceleration of the axis is small with respect to a set maximum value of the command acceleration; and
a display unit that highlights the portion.

2. The display device according to claim 1, wherein the display unit is capable of displaying a portion corresponding to the portion in the machining program.
